(19) United States
(12) Patent Application Publication
(10) Pub. No.: US 2024/0010475 A1
(43) Pub. Date: Jan. 11, 2024

(54) Load Height Detection System and Method

(71) Applicant: Deere & Company, Moline, IL (US)

(72) Inventor: Teemu K. Kananoja, Tampere (FI)

(21) Appl. No.: 18/295,870

(22) Filed: Apr. 5, 2023

(30) Foreign Application Priority Data
Jul. 11, 2022 (EP) 22184141.4

(51) Int. Cl. B66C 13/46; B60P 1/54; A01G 23/00

(52) U.S. Cl. CPC B66C 13/46; B60P 1/5433; A01G 23/003

(57) ABSTRACT

A load height detection system having a load space, a crane comprising multiple booms and a boom tip. A grapple tool is adapted to handle cargo, being attached to the boom tip, and is adapted to provide sensor data for open/close status. The crane has a vertical slew angle, a rotational angle, a horizontal distance of the boom tip to the base of the crane and a height position of the boom tip relative to the load space. A controller receives the positioning data of the crane and the boom tip, the controller being adapted to interpret the data of the vertical slew angle, the rotational angle, the distance and the height data to identify if the boom tip is inside or outside the load space, and to identify a loading or an unloading operation by an increasing or decreasing boom tip height in the area of the load space at a final position, the final position being defined by an open/close status of the grapple tool, and determining a fully loaded or fully unloaded load space.

### RELATED APPLICATIONS

This application claims priority to EP22184141.4 which is hereby incorporated by reference in its entirety.

### FIELD OF THE DISCLOSURE

The disclosure is a load height detection system for a load space provided on a vehicle, such as a forest vehicle for loading logs and a method for such a system.

### BACKGROUND OF THE DISCLOSURE

Loading bulk cargo on a load space of utility vehicles, in particular forestry vehicles, requires the operator to stack the cargo inside the load space until a fully loaded situation is achieved. It is common for the operators of forestry vehicles and the vehicle controllers to be in constant communication with the production system to update productivity data and product flow throughout the forest area and the product flow. Operation of forest vehicles requires planning of the material flow from the harvesting or cutting to loading and transporting the material to a nearby road network and to deliver the material for further processing. Log forwarder vehicles are used which provide a bunk or load space for placing the felled and cut logs for transportation.

The operator is required to provide feedback when the load space is fully loaded or unloaded to enable proper planning of the workflow. Providing such feedback can be burdensome, and can result in misleading information, such as load amount in weight or number of logs or wood type, as the operator must keep track on the required information and may make inaccurate inputs due to work stress or fatigue.

### SUMMARY OF THE DISCLOSURE

A load height detection system is provided comprising a load space, a crane comprising multiple booms and a boom tip, a grapple tool adapted to handle cargo and attached to the boom tip, being adapted to provide sensor data for open/close status. The crane can assume a vertical slew angle, a rotational angle, a horizontal distance of the boom tip to the base of the crane and a height position of the boom tip relative to the load space. A controller can be adapted to receive the positioning data of the crane and the boom tip. The controller can be adapted to interpret the data of the vertical slew angle, the rotational angle, the distance and the height data to identify if the boom tip is inside or outside the load space, and to identify a loading or an unloading operation by an increasing or decreasing boom tip height in the area of the load space at a final position, the final position being defined by an open/close status of the grapple tool, and determining a fully loaded or fully unloaded load space.

The system can enable an automatic detection of a loading or unloading process. The boom tip can repeatedly move outside the load space and inside the load space during operations. By recording a final position inside the load space before moving back outside the load space the controller can determine a loading or unloading operation. The vehicle on which the system is installed can be enabled to automatically transmit current operation data to the central production system so that the operator of the machine is relieved of manually providing such status messages. Further the production planner, usually situated off-site may follow the production process so that coordination efforts are greatly reduced. The production system may be enabled to provide information and data about the machine status and the log processing status such as log placement and transport time. The production planner and the operator thus experience less workload.

In another embodiment, a multiple of final positions can be recorded and the controller can be adapted to compare the multiple of final positions to identify a loading or an unloading operation, and indicating when an uppermost or lowermost position is reached.

The system can estimate an increase or decrease in the multiple of final positions such as the height value of the final positions. By incremental increase or decrease the system is able to estimate a loading and unloading operation. By comparing the values of the final positions with the dimension settings of the load space, the system can provide information to the operator and the production system about the current loading state.

In another embodiment, the final position can be a position where the boom tip stops and reverses the vertical direction, or where the grapple is actuated between an open or close state.

When the boom tip reverse movement is used to recognize a final position, the system can rely on less sensor input, being more durable and requiring less maintenance. When the open/close state of the grapple is used, this can provide a higher accuracy of load detection as compared to boom tip movement since the indication is more specific. The boom tip can in some occasions move up and down during operations inside the load space, so that the open close state of the grapple provide more reliant data.

By another embodiment, the controller can be adapted to collect the data and provide information about the current loading state of the load space.

The real time transmission of the current operations can provide a constant status to the production system by wireless communication. The operator and the production planner can have a constant overview of the production volume and the planning of further steps. The involved personal can experience a reduction of workload and are under reduced stress.

In a further embodiment, the measurement of the load space can be adaptable by the operator.

As modern forest machines also have an adaptable load space which can be extended in its dimensions, the operator can easily adapt the system to the changed load space characteristics. This enables a flexible work process, and the operator is supported in making the necessary changes to the load space and the system, so that the workload and stress of the operator is reduced.

In another embodiment, the final positions can be collected in a data table and the controller is adapted to identify the loading status in relation to the data input by an operator.

The system enables the operator to manually set a load space size or volume wherein the system uses this setting to identify a load height and a fully loaded or fully empty status of the load space and enables transmitting the information to the product planning system and/or planner work staff. This reduces workload on the operator and leads to a more accurate estimate of current work and task conditions.

### BRIEF DESCRIPTION OF THE DRAWINGS

Exemplary embodiments described in more detail below are illustrated in the drawings, in which:

FIG. 1 shows a forestry vehicle being a forwarder for load operations in forest areas;

FIG. 2 shows a view in a fore and aft direction of the load space or bunk of a forwarder;

FIG. 3 depicts the load-unload operation by the system showing the incremental changes of the final positions;

FIG. 4 shows the load space situation in a fully loaded state and the relative measurement by the system;

FIG. 5 depicts a record table of the system, estimating a load level and an average load level.

### DETAILED DESCRIPTION OF THE DRAWINGS

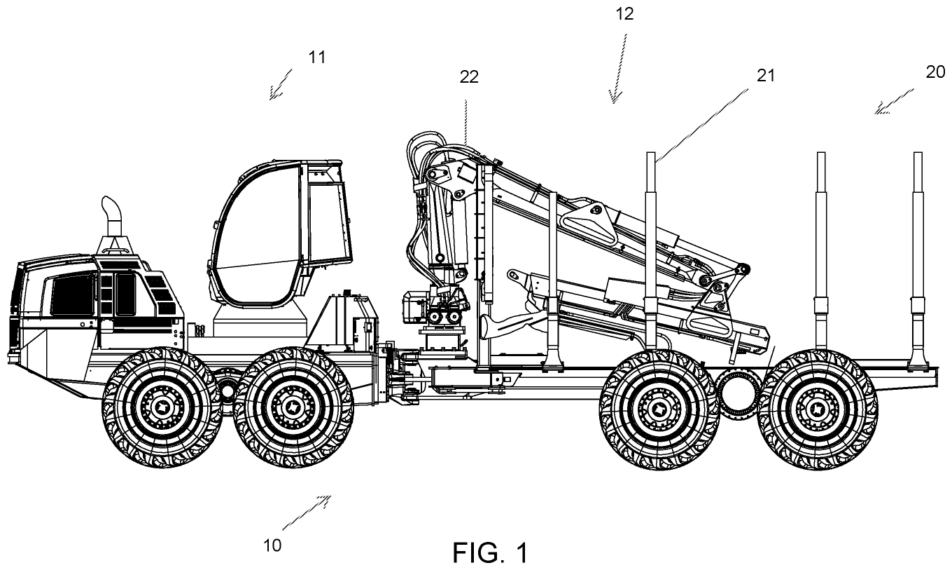

FIG. 1 shows a forestry vehicle 10, especially a forwarder. This vehicle type is used to transport logs from the harvesting area to a road transport vehicle or loading station. The vehicle comprises a front chassis 11 and rear chassis 12. The rear chassis 12 usually carries a load space 20 or a load bunk. The load space 20 can be surrounded by stakes 21 which ensure the placement of the logs. The load space 20 can be loaded by a crane 22, usually comprising multiple booms and an extension boom with a load grapple to handle logs. The crane 22 can be moved between the log pile and the load space 20 repeatedly to load the logs inside the load space 20. The crane 22 can be controlled by hydraulic power but can also be actuated by electric motors or similar power. Depending on the size of the vehicle, the load space 20 or the logs, the crane 22 may have a higher or lower lift capacity. The operator controls the crane operation and visually controls the filling of the load space 20. The crane 22 may have multiple sensors 23 so as to measure a slew angle, a horizontal and vertical position of the boom tip and a rotational angle relative to the length axis of the vehicle 10.

The crane 22 comprising multiple booms and a boom tip, a grapple tool adapted to handle cargo and attached to the boom tip, being adapted to provide sensor data for open/close status. The crane 22 can assume a vertical slew angle, a rotational angle, a horizontal distance of the boom tip to the base of the crane and a height position of the boom tip relative to the load space. A controller 25 can be adapted to receive the positioning data of the crane 22 and the boom tip. The controller 25 can be adapted to interpret the data of the vertical slew angle, the rotational angle, the distance and the height data to identify if the boom tip is inside or outside the load space, and to identify a loading or an unloading operation by an increasing or decreasing boom tip height in the area of the load space 20 at a final position, the final position being defined by an open/close status of the grapple tool, and determining a fully loaded or fully unloaded load space.

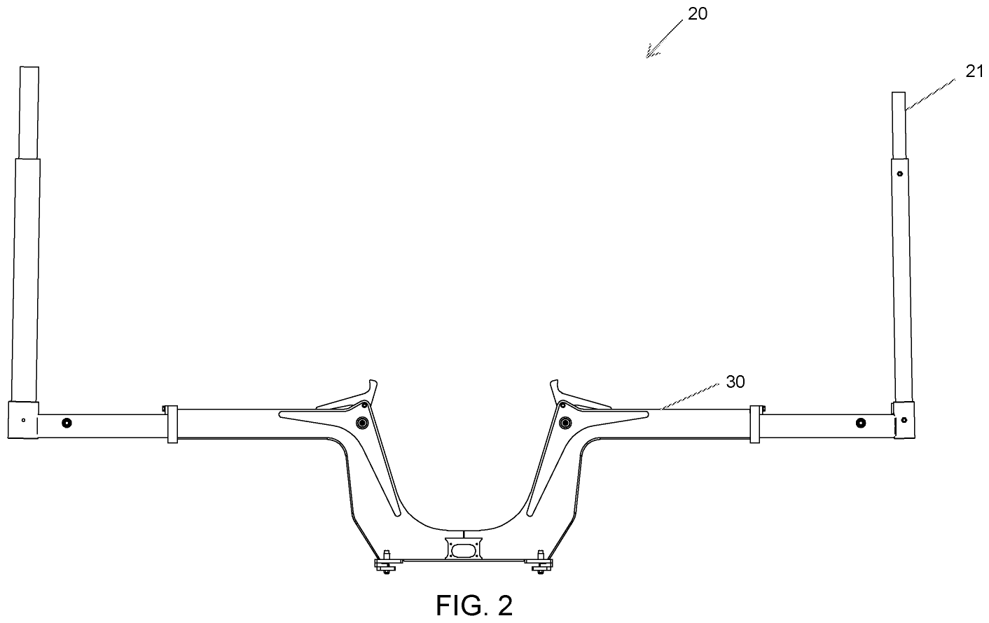

FIG. 2 depicts a partial view of the load space 20 showing a base 30 holding on each end the stakes 21 that surround the load space 20. During loading operation, the logs can pile up inside the load space 20 until the load limit, either limited by weight or by load height is reached. The load height is usually limited by the highest position of the stake tips and the lateral extension of the load stakes 21. The load space 20 can thus be enlarged in the vertical and horizontal direction. The forestry vehicle 10 may provide a motorized option for extending the load space 20 by hydraulic or electric power, so that the operator can control the load space volume from the operator seat without leaving the cabin. The system may calculate the load space 20 by positioning sensors in the stakes 21 and base 30 so that the volume is constantly updated in case of changes, or the operator can manually input the new volume as a setting inside the system. Furthermore, the operator can manually input the new intended volume of the load space 20 so that the system both changes the load space volume by actuating the relevant actuators and the system also at the same time adjusts the new volume for the calculation of the load situation.

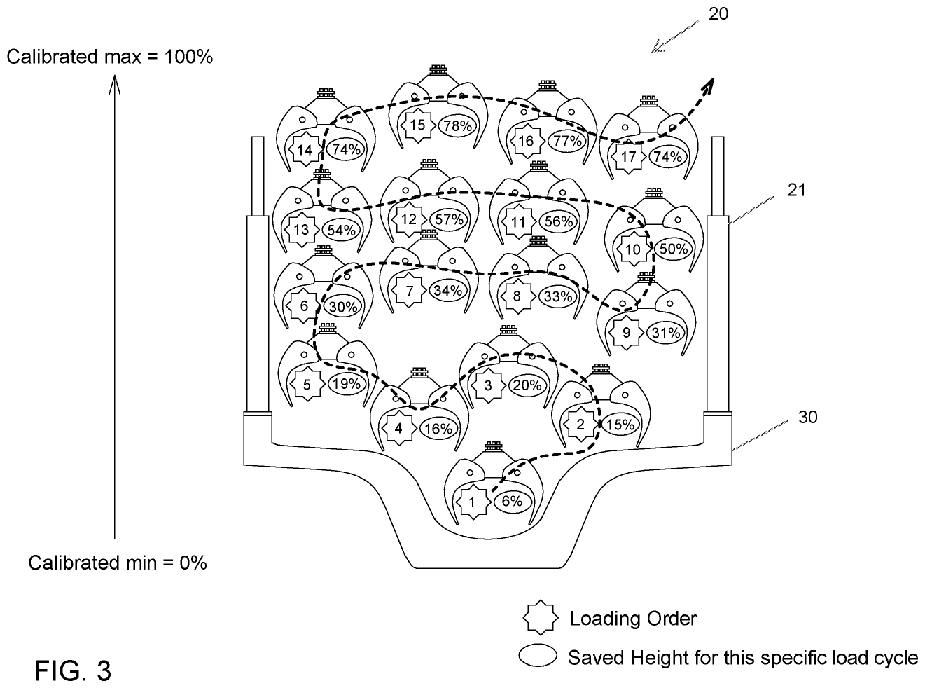

FIG. 3 shows a view of the load space 20 and the stakes 21 in a loading or unloading situation. The lowest log is identified by the system as log 1. The system can detect the lowest position of the grapple in an opening-closing situation which relates to the log being placed inside the load space 20 or being taken from the load space 20. The load space 20 or the crane 22 may comprise weight sensors 27 which enable the system to detect the weight of the log. The system may also function without a weight sensor. The weight sensor data can also be used to verify a loading or unloading operation. This depends on the weight reduction inside the load space 20 together with the opening closing operation of the grapple. In any case, with or without the weight sensor, the opening closing operation of the grapple may be counted as a first log placement and the height of the grapple position is recorded inside the system in a table.

The following movement of the crane 22 outside and inside the load space 20 in a second and different height position may be saved next as a new final position inside the table. In case of the provision of a weight sensor the added weight may also be saved in a table in the system.

During loading operations the load space 20 can further be filled up with logs and the system can recognize each new final position in the related look up table. The look up table can contain the complete set of final positions and can be enabled to count the load steps relating each to a different log and may automatically update the production team data via communication or computer device so that the operator is relieved of manual input in the system.

Once the system detects a final position matching the maximum available load space 20 the system can automatically set the load space 20 status to fully loaded and update the production team data accordingly. Further, the system may inform the operator that the load space 20 is in fully loaded state so that further load operation may cease at that time.

During an unloading operation the system works similarly. The new final positions will decrease in their height inside the load space 20 and the system can automatically update the production team data set. Similarly, this can also apply for the fully unloaded state.

If the system comprises a weight sensor, the system can alert the operator when a fully loaded state in regard to weight restrictions is reached. Also, the system may use the weight data to update the production team data set for the log weight and thus improve calculability of the processed log amount and weight.

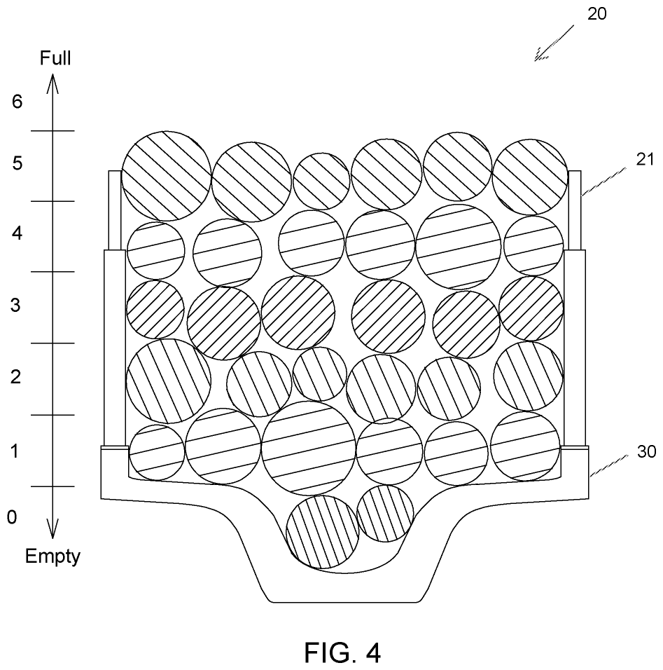

FIG. 4 shows an exemplary height model for the system, where the load height can be categorized in a scale shown on the left side. This scale may be only for referential purpose or may reflect the level of log layers placed in the load space 20. The system may categorize the final positions as being in a certain level of the load height and may determine if a final load height level for a fully loaded state is reached.

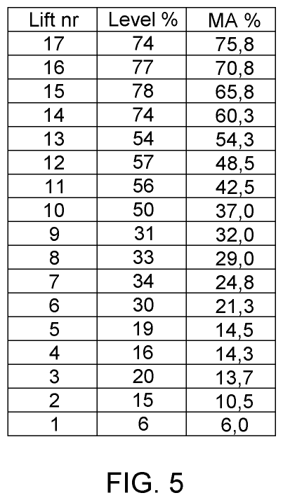

FIG. 5 depicts an example of a look up table of the system. The system may detect the number of load operations or load lifts and records each set in the table. For each final position inside the load space 20 the load height and or the load weight can be recorded. The system may verify the current loading operation by calculating if the height or weight is increasing or decreasing. For each loading operation, an average value can be calculated either for the height value or the weight value. With this method the system is able to constantly track the current operation and evaluate the increase or decrease of the final positions and also to calculate the limit of the load space 20, either by relying on the height value of the final positions or the load weight.

The system and the method work in summary as follows. At first, the system may detect the open or close movement of the grapple inside the load space 20. For this purpose, a specific positioning sensor may be provided, but is not mandatory. The open close command above a certain height level is sufficient inside a positioning window or border limit. The height position of the open-close position can be recorded in a table. The operator can repeat the loading process and a new final position in the moment of open-close movement can be detected and recorded. These steps can repeat during the loading or unloading process. When a new final position is detected that corresponds to the limit of the load space 20, the system can detect a fully loaded status. During the ongoing loading process the system can provide a constant data flow via communication devices to the operation center with the production team. Upon reaching fully loaded status the information can be updated via a communications link. The operation center and the planning office can keep track of current loading and estimated log production and transport.

What is claimed is:

1. A load detection system comprising:
a load space adapted to receive cargo and having a fully loaded and a fully unloaded status,
a crane comprising at least one boom and a boom tip, said crane being movable between multiple vertical angles and rotational angles,
a grapple tool adapted to handle cargo, being attached to the boom tip, having open and closed statuses, and being adapted to provide sensor data for open/close status, the crane being adapted to detect the vertical angle, the rotational angle, a horizontal distance of the boom tip to a base of the crane and a height position of the boom tip relative to the load space, and
a controller adapted to receive the position data of the crane and the boom tip, the controller being adapted to interpret the data of the vertical angle, the rotational angle, the distance and the height data to identify whether the boom tip is inside or outside the load space, and to identify a loading and an unloading operation by an increasing or decreasing boom tip height in the area of the load space at a final position, the final position being defined by an open/close status of the grapple tool, and determining when the load space is fully loaded and fully unloaded.

2. The load detection system of claim 1, wherein a multiple of final positions are recorded and the controller is adapted to compare the multiple of final positions to identify a loading and an unloading operation, and indicating, when an uppermost and lowermost position is reached.

3. The load detection system of claim 1, wherein the final position is a position where the boom tip stops and reverses in the vertical direction.

4. The load detection system of claim 1, wherein the final position is a position where the grapple is actuated between an open or close state.

5. The load detection system of claim 1, where the controller is adapted to collect the data and provide information about the current loading state of the load space.

6. The load detection system of claim 1, where the measurement of the load space is adaptable by the operator.

7. The load detection system of claim 1, wherein the final positions are collected in a data table and the controller is adapted to identify the loading status in relation to the data input by an operator.

8. A load detection system comprising:
a load space adapted to receive cargo and having a fully loaded and a fully unloaded status,
a crane comprising at least one boom and a boom tip, said crane being movable between multiple vertical angles and rotational angles, a grapple tool adapted to handle cargo, being attached to the boom tip, having open and closed statuses, and being adapted to provide sensor data for open/close status,
the crane being adapted to detect the vertical angle, the rotational angle, a horizontal distance of the boom tip to a base of the crane and a height position of the boom tip relative to the load space,
a controller adapted to receive the position data of the crane and the boom tip, the controller being adapted to interpret the data of the vertical angle, the rotational angle, the distance and the height data to identify whether the boom tip is inside or outside the load space, and to identify a loading and an unloading operation by an increasing or decreasing boom tip height in the area of the load space at a final position, the final position being defined by an open/close status of the grapple tool, and determining when the load space is fully loaded and fully unloaded,
wherein a multiple of final positions are recorded and the controller is adapted to compare the multiple of final positions to identify a loading and an unloading operation, and indicating, when an uppermost and lowermost position is reached, and
wherein the final position is a position where the boom tip stops and reverses in the vertical direction.

9. The load detection system of claim 8, where the controller is adapted to collect the data and provide information about the current loading state of the load space.

10. The load detection system of claim 9, where the measurement of the load space is adaptable by the operator.

11. The load detection system of claim 10, wherein the final positions are collected in a data table and the controller is adapted to identify the loading status in relation to the data input by an operator.

12. The load detection system of claim 11, wherein the final position is a position where the boom tip stops and reverses in the vertical direction.

13. A load detection system comprising:
a load space adapted to receive cargo and having a fully loaded and a fully unloaded status,
a crane comprising at least one boom and a boom tip, said crane being movable between multiple vertical angles and rotational angles,
a grapple tool adapted to handle cargo, being attached to the boom tip, having open and closed statuses, and being adapted to provide sensor data for open/close status, the crane being adapted to detect the vertical angle, the rotational angle, a horizontal distance of the boom tip to a base of the crane and a height position of the boom tip relative to the load space,
a controller adapted to receive the position data of the crane and the boom tip, the controller being adapted to interpret the data of the vertical angle, the rotational angle, the distance and the height data to identify whether the boom tip is inside or outside the load space, and to identify a loading and an unloading operation by an increasing or decreasing boom tip height in the area of the load space at a final position, the final position being defined by an open/close status of the grapple tool, and determining when the load space is fully loaded and fully unloaded,
wherein a multiple of final positions are recorded and the controller is adapted to compare the multiple of final positions to identify a loading and an unloading operation, and indicating, when an uppermost and lowermost position is reached, and
wherein the final position is a position where the grapple is actuated between an open or close state.

14. The load detection system of claim 13, where the controller is adapted to collect the data and provide information about the current loading state of the load space.

15. The load detection system of claim 14, where the measurement of the load space is adaptable by the operator.

16. The load detection system of claim 15, wherein the final positions are collected in a data table and the controller is adapted to identify the loading status in relation to the data input by an operator.

17. The load detection system of claim 16, wherein the final position is a position where the boom tip stops and reverses in the vertical direction.
